(19) United States
(12) Patent Application Publication
(10) Pub. No.: US 2024/0427067 A1
(43) Pub. Date: Dec. 26, 2024

(54) FILTER

(71) Applicant: PLATINUM OPTICS TECHNOLOGY INC., Taoyuan City (TW)

(72) Inventors: Shih-Song Cheng, Taoyuan City (TW); Bo-Xun Zhu, Taoyuan City (TW); Jia-Cheng Chang, Taoyuan City (TW); Kuan-Yu Chen, Taoyuan City (TW); Hung-Han Duan, Taoyuan City (TW); Shi-Lin Zhang, Taoyuan City (TW); Bo-En Zhu, Taoyuan City (TW)

(73) Assignee: PLATINUM OPTICS TECHNOLOGY INC., Taoyuan City (TW)

(21) Appl. No.: 18/743,919

(22) Filed: Jun. 14, 2024

(30) Foreign Application Priority Data
Jun. 16, 2023 (TW) 112122734

(51) Int. Cl. G02B 5/20; G02B 1/113; G02B 1/14

(52) U.S. Cl. CPC G02B 5/208; G02B 1/113; G02B 1/14

(57) ABSTRACT

Provided is a filter, including a substrate layer and a near-infrared absorption layer on the substrate layer, wherein the near-infrared absorption layer includes a copper complex formed from a copper compound for supplying copper ion, phosphonric acid represented by formula 1 herein, and at least one phosphorus-containing compound represented by formulas 2 to 4 herein, wherein the OD value of the filter for the incident light wavelength from 930-950 nm is greater than 4. In the present disclosure, by setting a specific near-infrared absorption layer on the filter, the filter is able to efficiently absorb near-infrared and exhibit excellent visible light transmittance, and the burden of film post-processing can be reduced.

### CROSS-REFERENCE TO RELATED APPLICATION

This application claims the benefit of priority of Taiwan Patent Application No. 112122734, filed Jun. 16, 2023, the entire contents of which are hereby incorporated by reference.

### BACKGROUND

### Technical Field

The present disclosure relates to a filter; more particularly, to a filter containing a near-infrared absorption layer, and the near-infrared absorption layer comprises a copper complex.

### Description of Associated Art

Near-infrared absorption filters have been broadly used in optical devices such as image sensors, and the near-infrared absorption filters currently used cannot satisfy the new needs as the requirements for imaging accuracy and optical qualities of images in the market increase. Therefore, there is a need in the art for a near-infrared absorption filter having a good transmittance in the visible band and a good shielding effect (i.e., a low transmittance which is even lower than the current ones of 8-15%) on the near-infrared band to respond to the requirement for increasingly harsh standards.

On the other hand, the optical recognition element broadly used currently employs near-infrared ray, particularly the near-infrared ray at the wavelength of 940 nm as the recognition light source, and thus, in a device integrated with an optical recognition element and an image sensor, the filter of the image sensor must effectively shield the recognition light source.

The filtering effect of an absorption type filter is related to its thickness. The thinner the filter, the better the transmittance, and the thicker the filter, the more significant the filtering effect. Technical means to improve filtering effect have been reported in well-known techniques by increasing the thickness of the material, such as e.g., blue glass, absorption dye layer, etc., having the function of near-infrared cutoff, or by increasing the number or thickness of optical coatings such as anti-reflective film, etc. However, due to the increasing interest in portability (e.g., size constraints such as weight, height, depth, width, size, light, thin, short, small, etc.) in the market, the technical means to improve optical properties by increasing the thickness of materials or coatings is no longer in line with market demand.

Moreover, although the filtering effect can be enhanced by increasing the coating thickness, the material processability and process difficulty deteriorate with an increase in coating thickness and complexity; additionally, the loss rate also increases, leading to a rise in costs and a decrease in industrial utilization. The increase in the coating thickness also causes poor quality of images, which doesn't meet the demands of high clarity in the market.

### SUMMARY

Given the problems mentioned above, the present disclosure provides a filter, comprising:
a substrate layer; and
a near-infrared absorption layer on the substrate layer, wherein the near-infrared absorption layer comprises:
a copper complex which is formed by a copper compound used for providing copper ions, a phosphonic acid represented by Formula 1, and at least one phosphor-containing compound represented by Formulas 2 to 4,

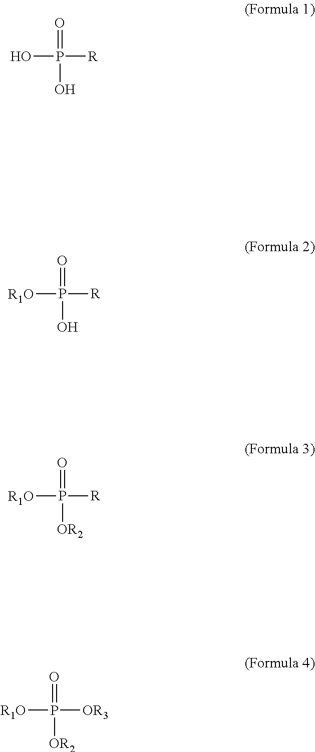

wherein R, R₁, R₂ and R₃ are each independently substituted or unsubstituted C₁-C₁₂ alkyl or substituted or unsubstituted C₆-C₁₂ aryl,
wherein the OD value of the filter for the incident light wavelength of 930-950 nm is greater than 4.

In an embodiment, the substituted or unsubstituted C₁-C₁₂ alkyl is selected from the group consisting of methyl, ethyl, n-propyl, iso-propyl, n-butyl, sec-butyl, iso-butyl, tert-butyl; and the substituted or unsubstituted C₆-C₁₂ aryl is selected from the group consisting of phenyl, naphthyl and chlorophenyl.

In an embodiment, the near-infrared absorption layer has a haze of 0.4% or less or about 0.4% or less.

In an embodiment, an X-ray photoelectron spectroscopy spectrum of the near-infrared absorption layer has at least one principal peak at binding energy of 930-940 eV. In a further embodiment, the at least one principal peak in the X-ray photoelectron spectroscopy spectrum has counts per second of 4500 or more.

In an embodiment, the near-infrared absorption layer has a thickness of 25-150 μm.

In an embodiment, the OD of the filter for the incident light wavelength of 940 nm is greater than 4.5.

In an embodiment, the near-infrared absorption layer further comprises an optical resin in which a copper complex is dispersed. In an embodiment, the optical resin is a thermoplastic resin and/or a photocurable resin. In an embodiment, the optical resin is selected from polycarbonates, polyesters, polycycloolefins, polyacrylics, siloxane resins and polyimides.

In an embodiment, the filter further comprises a filtering layer on the substrate layer on the side opposite to the near-infrared absorption layer.

In an embodiment, the filtering layer comprises a first absorption dye layer and a second absorption dye layer, wherein the first absorption dye layer comprises a near-infrared absorption dye, and the second absorption dye layer comprises an ultraviolet absorption dye.

In an embodiment, the near-infrared absorption dye is at least one selected from the group consisting of azo compounds, di-iminium compounds, benzene dithiol metal complexes, squaraine compounds, cyanine compounds and phthalocyanine compounds.

In an embodiment, the ultraviolet absorption dye is at least one selected from the group consisting of azomethylene compounds, indole compounds, ketone compounds, benzimidazole compounds and triazine compounds.

In an embodiment, each of the first and the second absorption dye layers has a thickness of 0.5-10 μm, and the filtering layer has an overall thickness of 0.5-10 μm.

In an embodiment, the filter further comprises at least one anti-reflective layer on the outermost side of the filter.

In an embodiment, the at least one anti-reflective layer is made of at least one selected from TiO₂, SiO₂, Y₂O₃, MgF₂, Al₂O₃, Nb₂O₅, AlF₃, Bi₂O₃, Gd₂O₃, LaF₃, PbTe, Sb₂O₃, SiO, SiN, Ta₂Os, ZnS, ZnSe, ZrO₂, and Na₃AlF₆, and has a thickness of 0.5-10 μm.

In an embodiment, the filter further comprises a protective layer which is made of an optical resin.

In an embodiment, the protective layer has a thickness of 10-30 μm and is disposed between the infrared absorption layer and the anti-reflective layer.

In an embodiment, the filter has an overall thickness of 225-800 μm.

In an embodiment, the filter has a passband overlaid with the wavelength range of 350-850 nm, and the central wavelength of the passband is in the wavelength range of 350-850 nm.

In an embodiment, the filter has a haze of 0.5% or less.

In an embodiment, the filter has maximum transmittance of 0.01% or less for the incident light wavelength range of 930-950 nm; maximum transmittance of 0.005% or less for the incident light wavelength range of 930-950 nm; minimum transmittance of 80% or more for the incident light wavelength range of 460-560 nm; and minimum transmittance of 85% or more for the incident light wavelength range of 460-560 nm

In an embodiment, there is a shift in the central wavelength of the passband when incident light irradiates the filter at incident angles of 0° vs. 30°, and the shift is 1.4 nm or less; and there is a shift in the central wavelength of the passband when incident light irradiates the filter at incident angles of 0° vs. 35°, and the shift is 1.9 nm or less.

The filter of the present disclosure can effectively absorb incident light at a wavelength of 800-1000 nm, more particularly incident light at the wavelength of 940 nm, and has a high transmittance for visible light, through disposing of a particular near-infrared absorption layer in the filter. Therefore, the present disclosure achieves an excellent cutoff effect on near-infrared rays and maintains a high transmittance for visible light without increasing the thickness of the product, the coating thickness, and the complexity.

### BRIEF DESCRIPTION OF THE DRAWINGS

FIGS. 1A-1C and FIGS. 2-4 are schematic diagrams of exemplary filters of the present disclosure.

FIG. 5 is the X-ray photoelectron spectroscopy spectrum of the near-infrared absorption layer in Preparation Example 1.

FIG. 6 is a graph showing the transmittance curves of the first and the second filtering layers in Preparation Example 1.

FIG. 7 is a graph showing the transmittance curves of AF32 glass and of the filtering layer and near-infrared absorption layer in Preparation Example 1.

FIG. 8 is a graph showing the transmittance curves of three embodiments of the substrate layer, the substrate layer+filtering layer, and the substrate layer+near-infrared absorption layer+filtering layer.

FIG. 9 is a graph showing the transmittance curves of the filters of Example 1 and Comparative Example 1.

FIG. 10 is a graph showing the transmittance curves of the filters of Example 2 and Comparative Example 1.

FIG. 11 is a graph showing the transmittance curves of the filters of Example 3 and Comparative Example 1.

FIG. 12 is a graph showing the transmittance curves of the filters of Example 4 and Comparative Example 1.

FIG. 13 is a graph showing the OD values of the filters of Examples 1 to 4 for the incident light wavelength of 930-950 nm.

FIG. 14 is a graph showing the transmittance curves of the filter of Example 1 irradiated at incident angles of 0°, 30°, and 35°, respectively.

FIG. 15 is a graph showing the transmittance curves of the filter of Example 3 irradiated at incident angles of 0°, 30°, and 35°, respectively.

### DETAILED DESCRIPTION

The following describes the implementation of the present disclosure through specific embodiments, a person having ordinary skill in the art can easily understand the scope and effect of the present disclosure based on the content recorded herein.

It should be noted that the structures, proportions, sizes, etc. shown in the drawings attached to this specification are only used to exemplify the content disclosed in the specification for the understanding and reading of people skilled in this art, and are not intended to limit the scope of the present disclosure. The present disclosure may also be implemented or applied as described in the various examples. It is also possible to modify or alter the following examples for carrying out the present disclosure without violating its spirit and scope, for different aspects and applications. One of skill in the art will appreciate that structural modifications, changes in proportions, or adjustments in size of the disclosed embodiments will fall within the scope of the technical content disclosed in the present disclosure without affecting the effects that can be produced and the purposes that can be achieved by the present disclosure.

Meanwhile, terms such as “upper”, “first” and “second” recited in the specification are also used for clear description but not for defining the scope capable of being implemented by the present disclosure, the change or adjustment of their relative relationship without substantial alteration of the technical contents are also considered within the implementation scope of the present disclosure.

Unless stated otherwise, “comprising”, “containing” or “having” particular elements used herein means that other elements such as units, components, structures, regions, parts, devices, systems, steps and connection relationships can be also included rather than excluded.

Unless expressly stated otherwise, the singular forms “a”, “an” and “the” also include the plural forms, and the “or” and “and/or” can be used interchangeably herein.

The numeric ranges described herein are inclusive and combinable, and any value falling into the numeric ranges described herein can be used as the upper or lower limit to derive a subrange. For example, a numeric range of “25-200” should be understood to include any subranges between the endpoints 25 and 200, e.g., subranges of 25-150, 30-200, 30-150, etc. In addition, a value falling into each range described herein (e.g., between the upper and lower limits) should be considered to be included in the range described herein.

The present disclosure mainly provides a filter. More particularly, the filter of the present disclosure comprises a substrate layer and a near-infrared absorption layer thereon.

The near-infrared absorption layer of the present disclosure may be made of a near-infrared absorption composition. The near-infrared absorption composition may comprise a copper compound, a phosphonic acid, and a phosphorus-containing compound.

The copper compound is used mainly as a supply source of copper ions and well known copper compounds may be employed for providing divalent copper ions (Cu²⁺), such as copper salts, e.g., copper acetate or copper acetate hydrate, as well as anhydrides or hydrates of copper chloride, copper formate, copper stearate, copper benzoate, copper pyrophosphate, copper naphthenate, copper citrate. In an embodiment, the copper compound is copper acetate.

The phosphonic acid is represented by Formula 1 below,

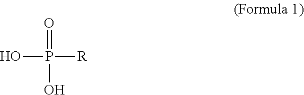

wherein R is substituted or unsubstituted C₁-C₁₂ alkyl or substituted or unsubstituted C₆-C₁₂ aryl.

The alkyl includes, but not limited to, methyl, ethyl, n-propyl, iso-propyl, n-butyl, sec-butyl, iso-butyl, tert-butyl, pentyl, etc., and examples of the substituted alkyl includes, but not limited to, haloalkyl, hydroxyalkyl, nitroalkykl, alkoxyalkyl, etc. The aryl includes, but not limited to, phenyl, nathphyl, etc., and examples of the substituted aryl includes, but not limited to haloaryl (e.g., chorophenyl), nitroaryl, hydroxyaryl, alkoxyaryl, haloalkylaryl, nitroalkylaryl, hydroxyalkylarykl, etc. In an embodiment, the phosphonic acid is butylphosphonic acid.

The phosphorus-containing compound is represented by Formulas 2-4 below,

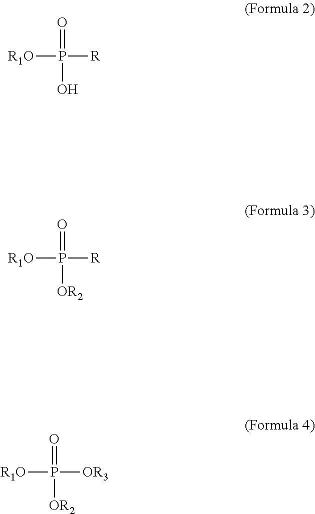

wherein R, R₁, R₂ and R₃ are each independently C₁-C₁₂ alkyl or C₆-C₁₂ aryl, which are defined as described for R in Formula 1.

The phosphorus-containing compound has a function of dispersion to make the components (including the copper complex formed) achieve uniform dispersing without agglutinating with each other. One effect of this function is to make a microcrystal size therein to be between 5 nm and 80 nm, or between 20 nm and 60 nm, e.g., 5, 10, 15, 20, 25, 30, 35, 40, 45, 50, 60, 70, 80, 90 and 100 nm. Sufficient near-infrared absorption property can be exhibited at a microcrystal size of 5 nm or more; while the product prepared from the near-infrared absorption composition has a relatively low haze due to the small number average particle size when the microcrystal size is 100 nm or less. In the present disclosure, to prepare the near-infrared absorption composition, at least one phosphorus-containing compound represented by Formulas 2 to 4 is used.

The proportions of the copper compound, the phosphonic acid, and the phosphorus-containing compound in the near-infrared absorption composition may be adjusted as needed. For example, in the near-infrared absorption composition, the copper compound may be of 1-150 weight parts, such as 1, 5, 10, 15, 20, 25, 30, 35, 40, 45, 50, 55, 60, 65, 70, 75, 80, 85, 90, 95, 100, 105, 110, 115, 120, 125, 130, 135, 140, 145 or 150 weight parts; the phosphonic acid may be of 1-100 weight parts, such as 1, 5, 10, 15, 20, 25, 30, 35, 40, 45, 50, 55, 60, 65, 70, 75, 80, 85, 90, 95 or 100 weight parts; and the phosphorus-containing compounds may be of 1-90 weight parts in total, such as 1, 5, 10, 15, 20, 25, 30 35, 40, 45, 50, 55, 60, 65, 70, 75, 80, 85 or 90 weight parts.

In an embodiment, the near-infrared absorption composition of the present disclosure comprises the phosphorus-containing compounds represented by Formulas 2 to 4 concurrently with the proportions can be adjusted as needed, for example, in the near-infrared absorption composition, the phosphorus-containing compound represented by Formula 2 may be of 1-90 weight parts, the phosphorus-containing compound represented by Formula 3 may be of 1-90 weight parts the phosphorus-containing compound represented by Formula 4 may be of 1-90 weight parts, wherein the phosphorus-containing compounds represented by Formulas 2 to 4 each may be, for example, of 1, 5, 10, 15, 20, 25, 30, 35, 40, 45, 50, 55, 60, 65, 70, 75, 80, 85 or 90 weight parts. In a further embodiment, the ratio of the phosphorus-containing compound represented by Formula 2: the phosphorus-containing compound represented by Formula 3: the phosphorus-containing compound represented by Formula 4 is 20:20:50.

In an embodiment, the near-infrared absorption composition of the present disclosure may be the form of a dispersion, i.e., the near-infrared absorption composition further comprises a solvent in addition to the copper compound, the phosphonic acid and the phosphorus-containing compound. During formulation, the copper compound, the phosphonic acid and the phosphorus-containing compound may be added into the solvent and mixed, the ratio of those components to the solvent may be 1:5 to 1:1, such as 1:3, but not limited thereto.

The solvent may be selected from those well-known, including but not limited to, water, alcohols, ketones, ethers, esters, aromatic hydrocarbons, halogenated hydrocarbons, dimethylformamide, dimethylacetamide, dimethyl sulfoxide, sulfolane, etc. Specifically, the alcohols are, for example, methanol, ethanol, propanol, etc. The esters are, for example, alkyl formates, alkyl acetates, alkyl propionate, alkyl butyrate, alkyl lactate, alkyl alkoxyacetate, alkyl 3-alkoxypropionate, alkyl 2-alkoxypropionate, alkyl 2-alkoxy-2-methylpropionate, alkyl pyruvate, alkyl acetylacetate, alkyl 2-oxobutyrate, etc. The ethers are, for example, diethylene glycol dimethyl ether, tetrahydrofuran, ethylene glycol monomethyl ether, ethylene glycol monoethyl ether, methylcellosolve acetate, ethylcellosolve acetate, diethylene glycol monomethyl ether, diethylene glycol monoethyl ether, diethylene glycol monobutyl ether, propylene glycol monomethyl ether, propylene glycol monomethyl ether acetate, propylene glycol monoethyl acetate, propylene glycol monopropyl ether acetate, etc. The ketones are, for example, methyl ethyl ketone, cyclohexanone, cyclopentanone, 2-heptanone, 3-heptanone, etc. The aromatic hydrocarbons are, for example, toluene, xylene, etc.

The mixing is, for example, stirring thoroughly at room temperature (e.g., 25° C.), such as for 4 hours or more, 6 hours or more, 8 hours or more, but not limited thereto.

The components in the near-infrared absorption composition react with each other to form a copper complex which may be represented by Cu²⁺X, wherein the Cu²⁺ is provided by the copper compound, and the X is contributed by the phosphonic acid and/or the phosphorus-containing compound.

In an embodiment, the near-infrared absorption composition may be further in the form of a coating solution. Specifically, the near-infrared composition in the form of a dispersion may be mixed with an optical resin to form a coating solution, wherein the ratio of the dispersion to the optical resin may be 5:1 to 1:1, or 3:1 to 1:1, such as 0.65:0.35, but not limited thereto. The near-infrared absorption composition in the form of a coating solution is used to be applied onto a substrate and baked for curing, to form the near-infrared absorption layer.

The optical resin may be a thermoplastic resin and/or a photocurable resin. In an embodiment, the optical resin is selected from polycarbonates, polyesters, polycycloolefins, polyacrylics, siloxane resins and polyimides. In an embodiment, the optical resin is a siloxane resin.

In addition, in order to perform the curing process, a curing agent, such as a photocuring agent, may be further added, thereby curing may be performed to form a film by light irradiation.

In an embodiment, the near-infrared absorption composition of the present disclosure has a haze of 0.4% or less, 0.3% or less, or 0.2% or less, e.g., 0.4%, 0.35%, 0.3%, 0.25%, 0.2%, 0.19%, 0.18%, 0.17%, 0.16%, 0.15%, 0.14%, 0.13%, 0.12%, 0.11% or 0.1%.

The thickness of the near-infrared absorption layer also has an effect on the properties of near-infrared absorption. In general, the cutoff capability for near-infrared rays increases as the thickness of the near-infrared absorption layer increases, however, this doesn't satisfy the requirement for thinning; while the cutoff capability for near-infrared rays decreases as the thickness of the near-infrared absorption layer decreases. In an embodiment, the near-infrared absorption layer of the present disclosure can achieve excellent cutoff capability for near-infrared rays even if its thickness is small. Specifically, the near-infrared absorption layer has a thickness between 25 μm and 150 μm, between 50 μm and 150 μm, or between 100 μm and 150 μm, e.g., 25 μm, 30 μm, 35 μm, 40 μm, 45 μm, 50 μm, 60 μm, 70 μm, 80 μm, 90 μm, 100 μm, 110 μm, 120 μm, 125 μm, 130 μm, 135 μm, 140 μm, 145 μm, 146 μm, 147 μm, or 150 μm.

In an embodiment, the X-ray photoelectron spectroscopy spectrum of the near-infrared absorption layer of the present disclosure has at least one principal peak at binding energy of 930-940 eV. In an embodiment, the at least one principal peak has counts per second of 4500 or more, 4600 or more, 4700 or more, 4800 or more, 4900 or more, or 5000 or more.

In an embodiment, for the incident light wavelength range of 930-950 nm (including for the incident light wavelength of 940 nm), the near-infrared absorption layer of the present disclosure has maximum transmittance of 0.1% or less, less than 0.1%, 0.05% or less, less than 0.05%, 0.01% or less, less than 0.01%, 0.005 or less, or less than 0.005%, e.g., 0.1%, 0.09%, 0.08%, 0.07%, 0.06%, 0.05%, 0.04%, 0.03%, 0.02%, 0.01%, 0.009%, 0.0008%, 0.007%, 0.0006%, 0.005%, 0.004%, 0.003%, 0.002% or 0.001%. In another aspect, for the incident light wavelength range of 930-950 nm (including for the incident light wavelength of 940 nm), the OD value is 3 or more, more than 3, 3.5 or more, more than 3.5, 4 or more, more than 4, 4.5 or more, or more than 4.5, e.g., 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9. In an embodiment, for the incident light wavelength range of 460-560 nm, the near-infrared absorption layer of the present disclosure has minimum transmittance of 80% or more or 85% or more, e.g., 80%, 81%, 82%, 83%, 84%, 85%, 86%, 87%, 88%, 89%, or 90%.

In an embodiment, the near-infrared absorption layer of the present disclosure has a passband overlaid with a wavelength range of 350-850 nm, 350-800 nm, or 350-750 nm, and the central wavelength of the passband is in the wavelength range of 350-850 nm, 350-800 nm, 350-750 nm, 400-700 nm, 450-650 nm, 500-600 nm, or 500-550 nm. Herein, “passband” refers to a range within which transmittance of 50% or more is exhibited for incident light in the wavelength range, and “central wavelength of the passband” refers to an average value of the two incident light wavelengths corresponding to the 50% transmittance exhibited for incident light.

In an embodiment, the substrate layer can be used for supporting the near-infrared absorption layer and aiding the filtering effect of the near-infrared absorption layer, thereby allowing the filter to exhibit better optical properties, such as further improving the cutoff effect on near-infrared rays and/or ultraviolet rays. The substrate layer may be made of glass, e.g., transparent glass (such as AF32 glass) or blue glass, wherein the substrate layer can exhibit a cutoff effect on near-infrared rays when blue glass is used. The blue glass is, e.g., phosphate glass, such as the blue glass formed from metaphosphate compounds, carbonate compounds, metal oxides and metal fluorides, wherein the metaphosphate compounds include, but not limited to, aluminum metaphosphate, magnesium metaphosphate, lithium metaphosphate, zinc metaphosphate, and calcium metaphosphate; the carbonate compounds include, but not limited to, calcium carbonate, barium carbonate, and strontium carbonate; the metal oxides include, but not limited to, copper oxide, aluminum oxide, zinc oxide, and magnesium oxide; and the metal fluorides include, but not limited to, aluminum fluoride, magnesium fluoride, calcium fluoride, strontium fluoride, barium fluoride, and zinc fluoride. The glass raw materials may be placed in a crucible after mixing uniformly, and the crucible is placed in an oven in atmosphere or reducing atmosphere while controlling the temperature between 700° C. and 1000° C. to yield homogenized glass.

In an embodiment, the substrate layer is made of blue glass, wherein the molar ratio of P/(Al+La+Nb+Y) may be 1.5-16, and the molar ratio of F/(F+O) may be 0.01-0.2. In an embodiment, the blue glass comprises 35-55 mol % of phosphorus element, 3.5-15 mol % of aluminum element, 15-25 mol % of alkali metal elements, 10-35 mol % of alkali earth metals and divalent metals, 10-21 mol % of copper element, and 0-7 mol % of lanthanum+niobium+yttrium in total, and wherein the molar ratio of Cu/P is 0.25-0.7, and the molar ratio of F/(F+O) is 0.01-0.2.

In an embodiment, the thickness of the substrate layer is between 200 μm and 500 μm, between 200 μm and 400 μm, or between 200 μm and 300 μm, e.g., 200 μm, 225 μm, 250 μm, 275 μm, 300 μm, 325 μm, 350 μm, 375 μm, 400 μm, 425 μm, 450 μm, 475 μm, or 500 μm.

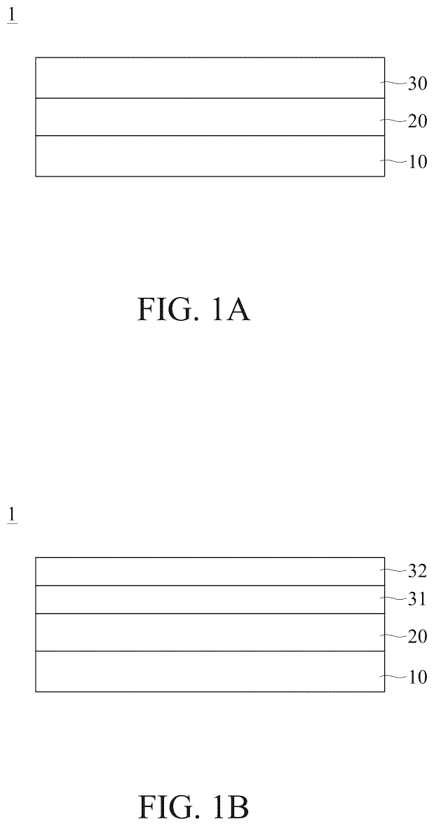

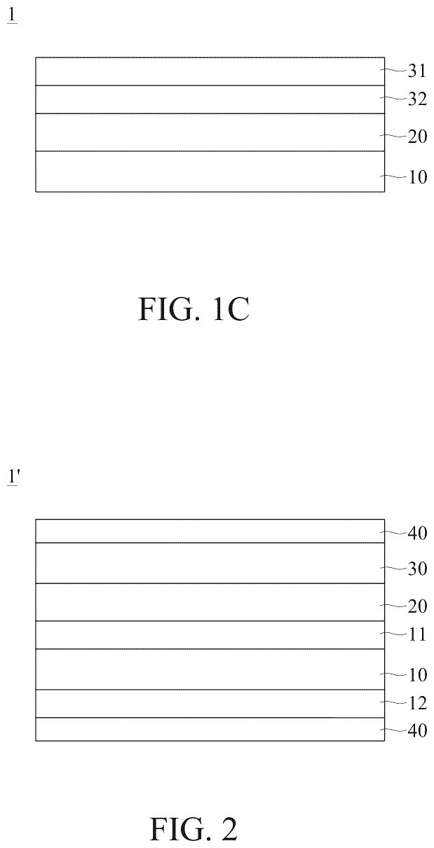

There is no limitation on the disposition order of layers in the filter of the present disclosure, for example, as shown in FIG. 1A, filter 1 comprises near-infrared absorption layer 10 and substrate layer 20, wherein near-infrared absorption layer 10 is on substrate layer 20.

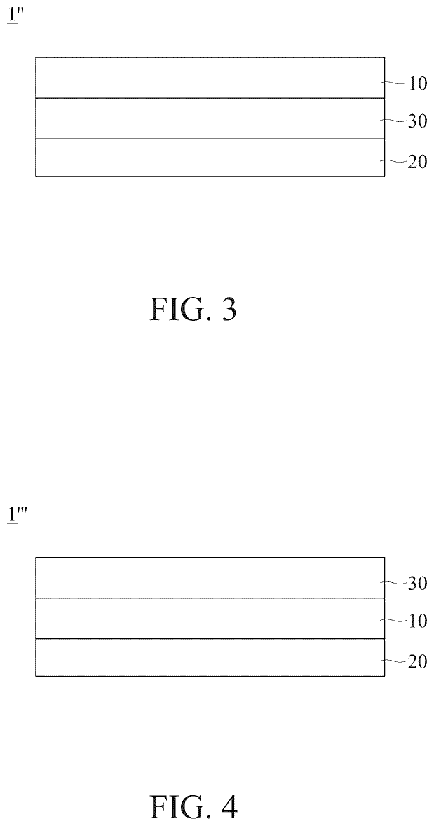

In an embodiment, the filter of the present disclosure further comprises a filtering layer. In an embodiment, there is no limitation on the disposition of the filtering layer in the filter, for example, as shown in FIG. 1A, filtering layer 30 is on substrate layer 20 on the side opposite to near-infrared absorption layer 10, i.e., near-infrared absorption layer 10 and filtering layer 30 are on different sides of substrate 20. In other embodiments, also as shown in FIG. 3, in filter 1″, filtering layer 30 is between near-infrared absorption layer 10 and substrate layer 20; and also as shown in FIG. 4, in filter 1′″, near-infrared absorption layer 10 is between filtering layer 30 and substrate layer 20.

The filtering layer may be used to assist the near-infrared absorption layer to exhibit more excellent optical properties, such as further improving the cutoff effect on near-infrared rays and/or ultraviolet rays. In an embodiment, the filtering layer may comprise a first absorption dye layer and a second absorption dye layer, which respectively comprise a near-infrared absorption dye and an ultraviolet absorption dye. As shown in FIGS. 1B and 1C, filtering layer 30 in filter 1 is specifically a bi-layered structure containing first absorption dye layer 31 and second absorption dye layer 32, but FIG. 1B differs from FIG. 1C in the order of first absorption dye layer 31 and second absorption dye layer 32.

The filtering layer may comprise a transparent resin including, but not limited to, one selected from epoxy resins, polyurethanes, polyacrylates, polyolefins, polycarbonates, polycycloolifins and poly(vinyl butyral), and the resin may be used as a substrate for the coating solution of the filtering layer.

The near-infrared absorption dye may be, for example, azo compounds, di-iminium compounds, benzene dithiol metal complexes, squaraine compounds, cyanine compounds and phthalocyanine compounds, and can adjust the maximum absorption wavelength to be between 650 nm and 1100 nm, or more specifically between 650 nm and 750 nm. The ultraviolet absorption dye may be, for example, azomethylene compounds, indole compounds, ketone compounds, benzimidazole compounds and triazine compounds.

In an embodiment, the filtering layer has a thickness of 0.5-10 μm, e.g., 0.5 μm, 1 μm, 2 μm, 3 μm, 4 μm, 5 μm, 6 μm, 7 μm, 8 μm, 9 μm or 10 μm. When the filtering layer is a multi-layered structure, such as a bi-layered structure containing a first absorption dye layer and a second absorption dye layer, each layer has a thickness of 0.5 μm-10 μm, e.g., 0.5 μm, 1 μm, 2 μm, 3 μm, 4 μm, 5 μm, 6 μm, 7 μm, 8 μm, 9 μm to 10 μm.

In an embodiment, the filter of the present disclosure further comprises at least one anti-reflective layer on the outermost side of the filter. As shown in FIG. 2, anti-reflective layers 40 are on both of the outermost sides of filter 1′.

In an embodiment, the anti-reflective layer is a coating formed from at least one material selected from TiO₂, SiO₂, Y₂O₃, MgF₂, Al₂O₃, Nb₂O₅, AlF₃, Bi₂O₃, Gd₂O₃, LaF₃, PbTe, Sb₂O₃, SiO, SiN, Ta₂Os, ZnS, ZnSe, ZrO₂, and Na₃AlF₆. In an embodiment, the anti-reflective layer is formed by alternately depositing a TiO₂ layer and a SiO₂ layer.

In an embodiment, the anti-reflective layer has a thickness of 0.5-10 μm, e.g., 0.5 μm, 1 μm, 2 μm, 3 μm, 4 μm, 5 μm, 6 μm, 7 μm, 8 μm, 9 μm or 10 μm.

In an embodiment, the filter of the present disclosure further comprises a protective layer which is made of an optical resin. The optical resin herein may reference the optical resin used in the near-infrared absorption composition in the form of a coating solution.

In an embodiment, the protective layer has a thickness of 10-30 μm, e.g., 10 μm, 15 μm, 25 μm or 30 μm. In an embodiment, the protective layer is on the near-infrared absorption layer, or between the near-infrared absorption layer and the layer covering it. As shown in FIG. 2, protective layer 12 is between near-infrared absorption layer 10 and anti-reflective layer 40. The protective layer is used to protect the near-infrared absorption layer. Due to the soft nature of the near-infrared absorption layer, scratches may be easily present on the surface and even falling off may occur when it is directly subjected to subsequent treatments. Thus, such damage to the near-infrared absorption layer can be prevented by forming a protective layer thereon.

In an embodiment, the filter of the present disclosure further comprises an adhesive layer between the near-infrared absorption layer and the substrate layer. As shown in FIG. 2, adhesive layer 11 is between near-infrared absorption layer 10 and substrate layer 20. The adhesive layer may employ materials known in the art for bonding two adjacent layers, for example, hexamethyldisilazane (HMDS). The adhesive layer is used to protect the near-infrared absorption layer from releasing from the substrate layer under certain conditions, to enhance the stability of the filter.

In an embodiment, the filter of the present disclosure comprises: a substrate layer, a near-infrared absorption layer, a filtering layer, an adhesive layer, a protective layer, and anti-reflective layers. As shown in FIG. 2, filter 1′ of the present disclosure comprises substrate layer 20, near-infrared absorption layer 10 on one side of substrate layer 20, adhesive layer 11 between substrate layer 20 and near-infrared absorption layer, filtering layer 30 on the other side of substrate layer 20, protective layer 12 on near-infrared absorption layer 10, and anti-reflective layers 40 on both of the outermost sides of the filter.

In an embodiment, the filter of the present disclosure has an overall thickness of about 225 μm to about 800 μm, about 250 μm to about 500 μm, or about 300 μm to about 500 μm, e.g., about 225 μm, about 250 μm, about 275 μm, about 300 μm, about 325 μm, about 350 μm, about 375 μm, about 400 μm, about 425 μm, about 450 μm, about 475 μm, about 500 μm, about 550 μm, about 600 μm, about 650 μm, about 700 μm, about 750 μm, or about 800 μm.

In an embodiment, the filter of the present disclosure has a haze of 0.5% or less, 0.4% or less, or 0.3% or less, e.g., 0.5%, 0.45%, 0.4%, 0.35%, 0.3%, 0.25%, 0.2%, 0.19%, 0.18%, 0.17%, 0.16%, 0.15%, 0.14%, 0.13%, 0.12%, 0.11% or 0.1%.

In an embodiment, for the incident light wavelength range of 930-950 nm (including for the incident light wavelength of 940 nm), the filter of the present disclosure has maximum transmittance of 0.01% or less, less than 0.01%, 0.005% or less, or less than 0.005%, e.g., 0.01%, 0.009%, 0.008%, 0.007%, 0.006%, 0.005%, 0.004%, 0.003%, 0.002%, 0.001%; on the other hand, the OD value for the incident light wavelength range of 930-950 nm (including for the incident light wavelength of 940 nm) is 4 or more, more than 4, 4.5 or more, more than 4.5, 4.8 or more, or more than 4.8, e.g., 4, 4.01, 4.1, 4.2, 4.3, 4.4, 4.5, 4.51, 4.6, 4.7, 4.8, 4.81, 4.9. In an embodiment, for the incident light wavelength range of 460-560 nm, the filter of the present disclosure has minimum transmittance of 80% or more, or 85% or more, e.g., 80%, 81%, 82%, 83%, 84%, 85%, 86%, 87%, 88%, 89%, or 90%.

In an embodiment, the filter of the present disclosure has a passband overlaid with a wavelength range of 350-850 nm, 350-800 nm, or 350-750 nm, and the central wavelength of the passband is in the wavelength range of 350-850 nm, 350-800 nm, 350-750 nm, 400-700 nm, 450-650 nm, 500-600 nm, or 500-550 nm.

In an embodiment, there is a shift in the central wavelength of the passband when incident light irradiates the filter of the present disclosure at an incident angle of from 0° to 30°, wherein the shift is of 1.4 nm or less, e.g., 1.4 nm, 1.3 nm, 1.2 nm, or 1.1 nm. In an embodiment, there is a shift in the central wavelength of the passband when incident light irradiates the filter of the present disclosure at an incident angle of from 0° to 35°, wherein the shift is of 1.9 nm or less, e.g., 1.9 nm, 1.8 nm, or 1.7 nm.

### EXAMPLES

Further details will be described in the present disclosure by referencing to following specific Examples which are not intended to limit the scope of the present disclosure.

### Preparation Example 1

### Near-Infrared Absorption Layer

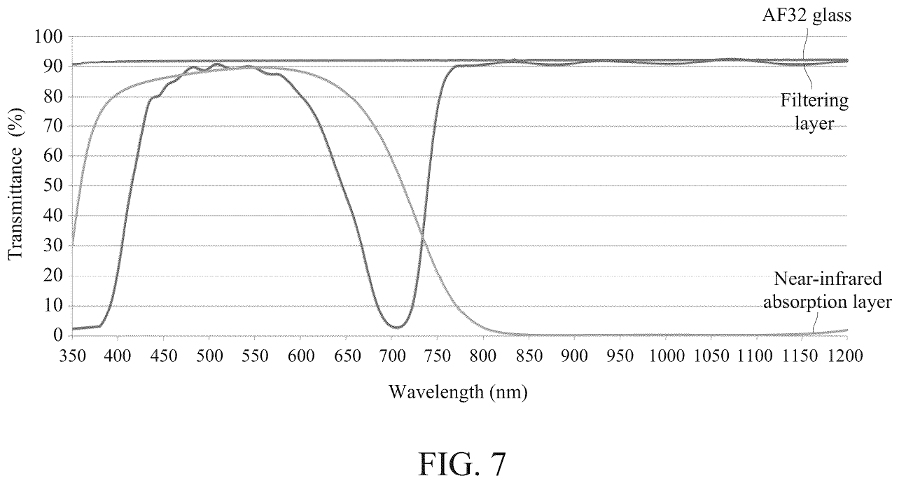

150 Weight parts of copper acetate were mixed with 15000 weight parts of ethanol and stirred at room temperature for 1.5 hrs to form a first mixture. Additionally, 20 weight parts of the phosphorus-containing compound represented by Formula 2 (plysurf A242G, purchased from Daiichi Pharmaceutical Co., Ltd.), 20 weight parts of the phosphorus-containing compound represented by Formula 3 (plysurf W542C, purchased from Daiichi Pharmaceutical Co., Ltd.,) and 50 weight parts of the phosphorus-containing compound represented by Formula 4 (plysurf A285C, purchased from Daiichi Pharmaceutical Co., Ltd.) were mixed with 1500 weight parts of ethanol to form a second mixture. The first and the second mixtures were mixed and stirred at room temperature for 1 hr, and then 100 weight parts of butylphosphonic acid were added and stirred at room temperature to react for 3 hrs. Thereafter, the reaction mixture was placed in an oven at 85° C. for 12 hrs to obtain powder. The powder was mixed with xylene at a weight ratio of 1:3 to form a dispersion, the dispersion was mixed with an optical resin at a weight ratio of 0.65:0.35 to form a coating solution, and the coating solution was coated on a substrate and baked at 70° C. for 30 minutes, yielding a near-infrared absorption layer. The transmittance curve of the near-infrared absorption layer was shown in FIG. 7.

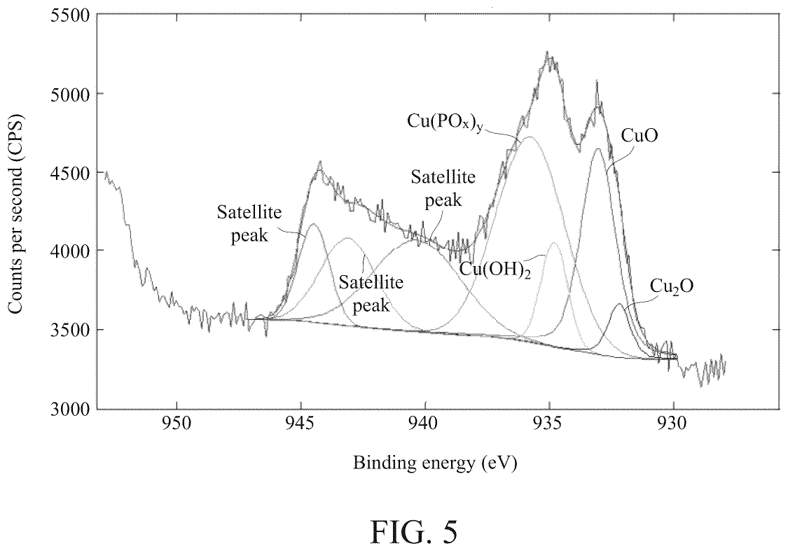

An X-ray photoelectron spectroscopy (ESCA/XPS) measurement was performed on the near-infrared absorption layer, and the X-ray photoelectron spectroscopy spectrum was shown in FIG. 5. Characteristic peaks related to the copper complex (Cu(POₓ)_{y}, CuO, Cu₂O, Cu(OH)₂) at binding energy of 930-940 eV were observed. Also, peaks occurred at binding energy of 940 eV or more were satellite peaks.

### Filtering Layer

0.02 g of squaraine compounds and cyanine compounds as infrared absorption dyes were added to 5 g of epoxy resin, and then the mixture was coated on a substrate and baked at 70° C. for 30 minutes to yield a first absorption dye layer. Additionally, 0.02 g of triazine compounds as an ultraviolet absorption dye was added to 5 g of epoxy resin, and then the mixture was coated on the substrate and baked at 70° C. for 30 minutes to yield a second absorption dye layer.

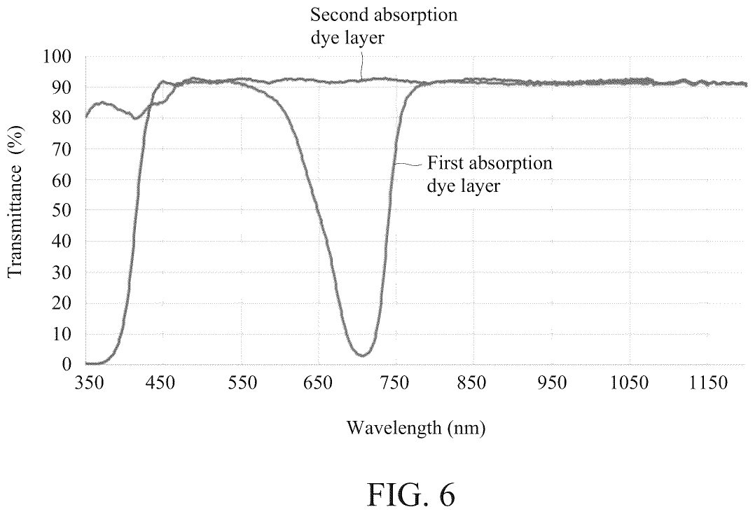

The transmittance curves of the first and the second absorption dye layers described above were shown in FIG. 6.

The first absorption dye layer as above was formed on a substrate, and the second absorption dye layer as above was further formed on the first absorption dye layer to form a filtering layer with a bi-layered structure, the transmittance curve of which was shown in FIG. 7.

### Preparation Example 2

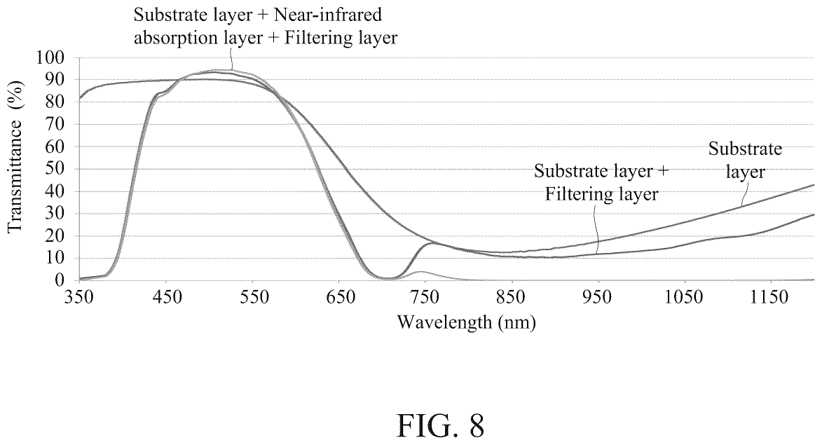

Blue glass was used as a substrate layer according to the present disclosure. Thereafter, a filtering layer was formed on one side of the blue glass substrate layer according to the method of Preparation Example 1. Then, a near-infrared absorption layer was formed on the other side of the blue glass substrate layer according to the method of Preparation Example 1. The transmittance curves of the substrate layer, the bi-layered structure of substrate layer+filtering layer, and the tri-layered structure of substrate layer+near-infrared absorption layer+filtering layer described above were shown in FIG. 8. It can be seen from the results that the filter having only the bi-layered structure of substrate layer+filtering layer had an insufficient cutoff effect on incident near-infrared light. In contrast, the filter having the tri-layered structure of substrate layer+near-infrared absorption layer+filtering layer exhibited an excellent cutoff effect on incident near-infrared light, particularly on incident light at the wavelength of 850 nm or more. Given this, the contribution of the near-infrared absorption layer can be seen, and the substrate layer+near-infrared absorption layer of the present disclosure largely improved the cutoff effect on near-infrared rays and maintained the high transmittance in the visible band.

### Example 1

The structures and dispositions of layers in the filter of Example 1 were shown in FIG. 2, in which the substrate layer was blue glass with a thickness of 200 μm; the adhesive layer was hexamethyldisilazane with a thickness of 60 μm; the near-infrared absorption layer was prepared according to the method of Preparation Example 1 and had a thickness of 145.44 μm; the protective layer was optical resin with a thickness of 10 μm; the filtering layer was prepared according to the method of Preparation Example 1 and had a thickness of 5 μm; and the anti-reflective layer was alternatively deposited TiO₂ layer and SiO₂ layer and had an overall thickness of 1 μm.

### Examples 2 to 4 and Comparative Example 1

Filters were prepared according to the method of Example 1 as Example 2 to 4, except that the thickness of the near-infrared absorption layer was altered to be 146.22 μm, 147.44 μm, and 146.63 μm, respectively. Further, a filter was prepared according to the method of Example 1 as Comparative Example 1, except that the thickness of the near-infrared absorption layer was altered to be 165.11 μm.

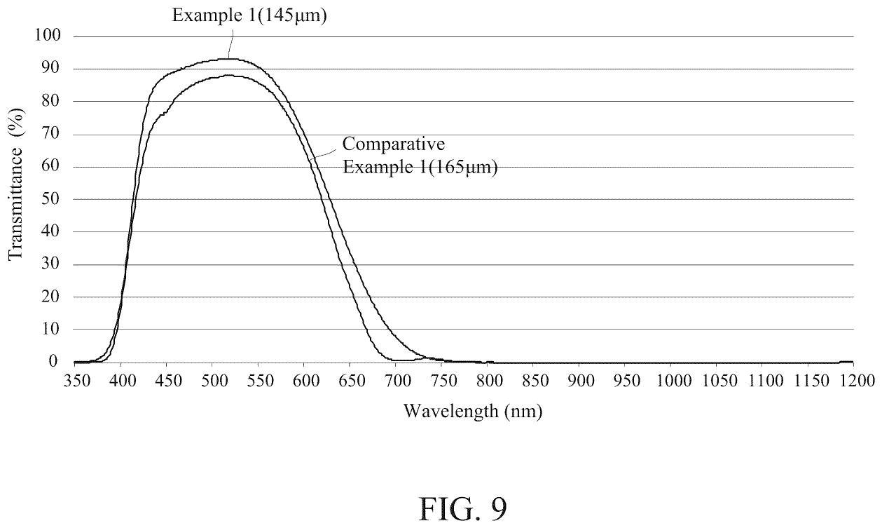

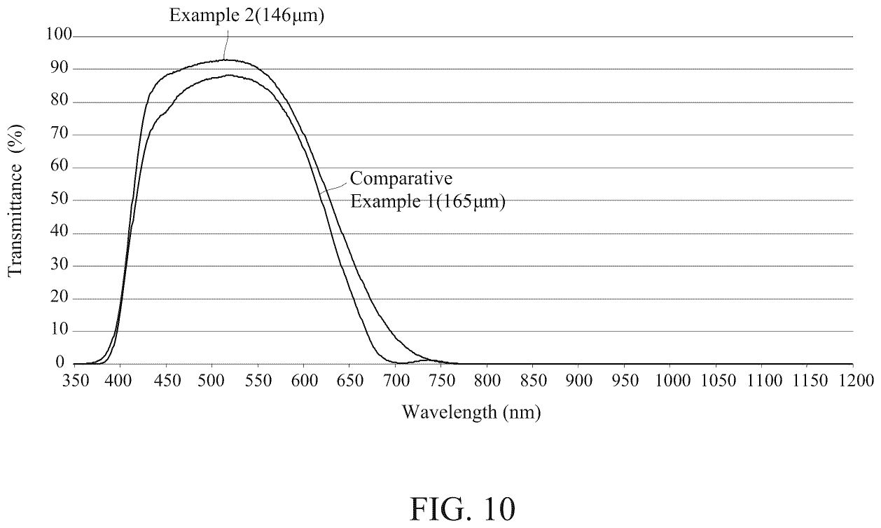

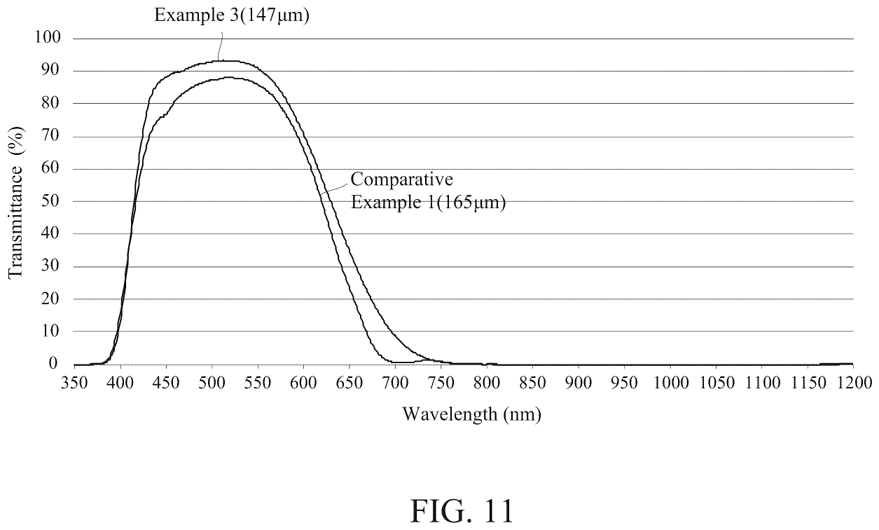

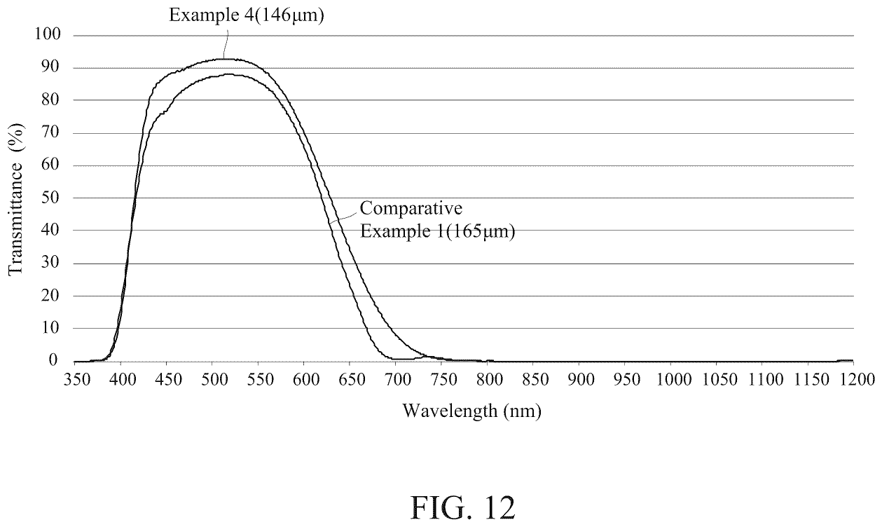

The transmittance curves of Examples 1 to 4 and Comparative Example 1 described above were shown in FIG. 9 to FIG. 12, and the transmittance data were shown in Table 1 below.

TABLE 1

| | | | | | | Comparative |
|---|---|---|---|---|---|---|
| | | Example 1 | Example 2 | Example 3 | Example 4 | Example 1 |
| Thickness of the near- | | 145.44 μm | 146.22 μm | 147.44 μm | 146.63 μm | 165.11 μm |
| infrared absorption film | | | | | | |
| (μm) | | | | | | |
| Tₘᵢₙ | 430 nm-460 nm | 78.91 | 79.65 | 78.56 | 77.80 | 68.42 |
| (%) | 460 nm-560 nm | 87.26 | 86.96 | 87.41 | 87.12 | 80.73 |
| Tₘₐₓ | 730 nm-830 nm | 1.93 | 2.22 | 2.34 | 2.05 | 1.33 |
| (%) | 830 nm-930 nm | 0.003116 | 0.006376 | 0.007998 | 0.003739 | 0.00411 |
| | 930 nm-950 nm | 0.001234 | 0.002962 | 0.003699 | 0.001537 | 0.001442 |
| | 950 nm-1050 nm | 0.001831 | 0.004276 | 0.005239 | 0.002182 | 0.001929 |
| | 830 nm-1200 nm | 0.052662 | 0.09601 | 0.108974 | 0.058741 | 0.054911 |
| Haze (%) | | 0.32 | 0.34 | 0.35 | 0.35 | 0.48 |
| OD | 930 nm-950 nm | 4.97 | 4.58 | 4.49 | 4.87 | 4.89 |

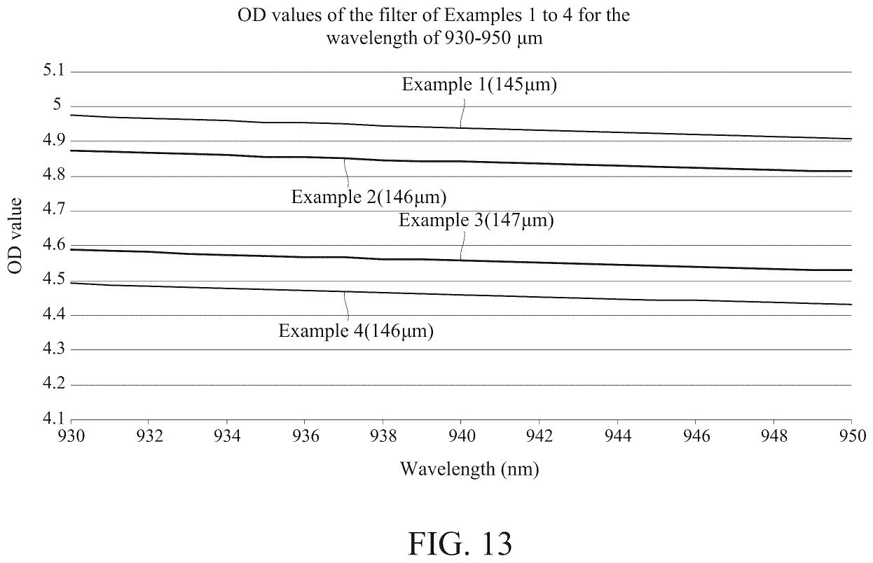

According to these results, for the incident light wavelength of 930-950 nm, the filters of the present disclosure had excellent cutoff properties and can even achieve an OD value of 4.5 or more. To further display OD values of the filters of the present disclosure for the incident light wavelength of 930-950 nm, OD value curves of the filters of Examples 1 to 4 for the wavelength of 930-950 nm were overlaid in FIG. 13 according to the transmittance curves and data. On the other hand, the filters of the present disclosure had excellent transmittances for visible light, which had passbands overlaid with the wavelength range of 350-850 nm, and the central wavelengths of the passbands were in the wavelength range of 350-850 nm.

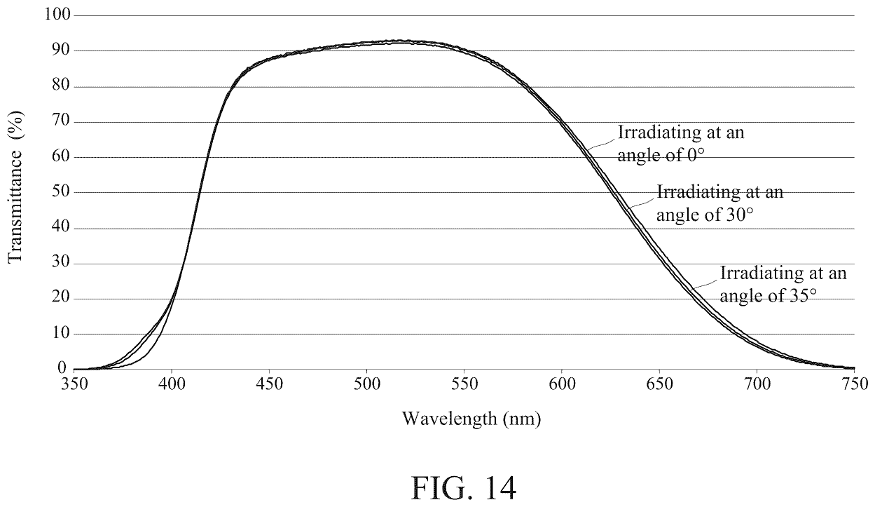

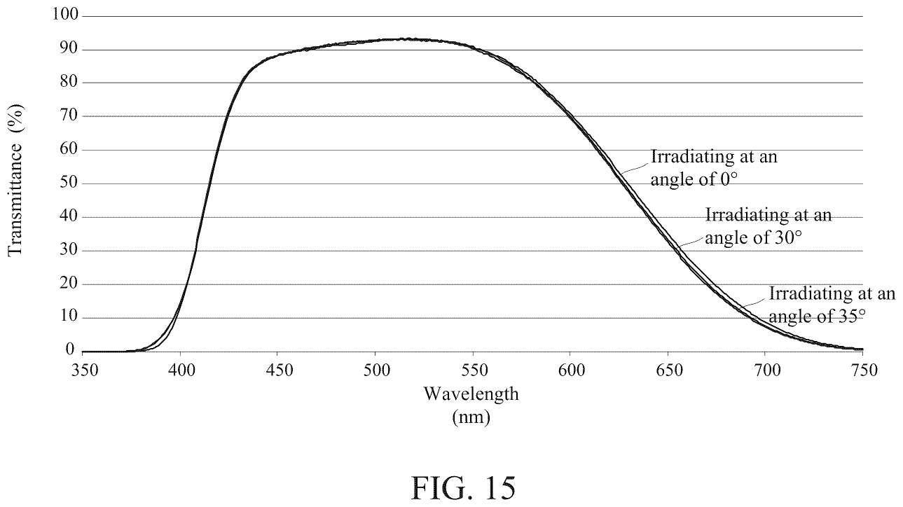

The level of shift can be observed from FIG. 14 which was the graph showing the transmittance curves of the filter of Example 1 irradiated with incident light at different angles of 0°, 30°, and 35°. Similarly, FIG. 15 was the graph showing the transmittance curve of the filter of Example 3 irradiated with incident light at different angles of 0°, 30°, and 35°. The results showed that the transmittance curves resulted from irradiating the filters at different angles were very similar. Taking the transmittance data of Example 1 and Example 3 (as shown in Table 2 below) as examples, the central wavelength of passbands shifted by 1.1 nm and 1.4 nm when the two filters were irradiated at incident angles of 0° vs. 30°, respectively; and the central wavelength of passbands shifted by 1.7 nm and 1.9 nm when the two filters were irradiated at incident angles of 0° vs. 35°, respectively. Compared to this, the central wavelength of passbands shifted by up to 9.6 nm when the filter of Comparative Example 2 (prepared according to the method of Example 1 but contained no near-infrared absorption layer) was irradiated at incident angles of 0° vs. 30°; and the central wavelength shifted by up to 10.1 nm when it was irradiated at incident angles of 0° vs. 35°, exhibiting a high level of shift. It is known that such a high level of shift will result in glare and ghosting. The filter of the present disclosure significantly decreases glare and ghosting and improves the quality of images due to the small level of shift.

TABLE 2

| | Incident angle | Incident angle | Incident angle |
|---|---|---|---|
| | of 0° | of 30° | of 35° |
| Example 1 | | | |
| Wavelength (UV band) corresponding | 414.1 nm | 414.0 nm | 414.0 nm |
| to the transmittance of 50% T_{50%UV} | | | |
| Wavelength (IR band) corresponding | 628.9 nm | 626.86 nm | 625.56 nm |
| to the transmittance of 50% T_{50%IR} | | | |
| Central wavelength = (T_{50%UV} + | 521.5 nm | 520.4 nm | 519.8 nm |
| T_{50%IR})/2 | | | |
| Shift relative to that at the incident | / | 1.1 nm | 1.7 nm |
| angle of 0° | | | |
| Example 3 | | | |
| T_{50%UV} | 415.2 nm | 414.8 nm | 414.4 nm |
| T_{50%IR} | 629.9 nm | 627.7 nm | 626.9 nm |
| Central wavelength = (T_{50%UV} + | 522.6 nm | 521.2 nm | 520.7 nm |
| T_{50%IR})/2 | | | |
| Shift relative to that at the incident | / | 1.4 nm | 1.9 nm |
| angle of 0° | | | |
| Comparative Example 2 | | | |
| T_{50%UV} | 414.6 | 406.7 nm | 406.4 nm |
| T_{50%IR} | 628.2 nm | 616.9 nm | 616.2 nm |
| Central wavelength = (T_{50%UV} + | 521.4 nm | 511.8 nm | 511.3 nm |
| T_{50%IR})/2 | | | |
| Shift relative to that at the incident | / | 9.6 nm | 10.1 nm |
| angle of 0° | | | |

The embodiments and specific examples described above are not intended to limit the present disclosure. The technical features or schemes listed can be combined with one another. The present disclosure can be implemented or applied by other different execution modes. Details recorded herein can be altered or modified differently according to different viewpoints and applications without departing from the present disclosure.

What is claimed is:

1. A filter, comprising:
a substrate layer; and
a near-infrared absorption layer formed on the substrate layer, wherein the near-infrared absorption layer comprises:
a copper complex which is formed by a copper compound for providing copper ions, a phosphonic acid represented by Formula 1, and at least one phosphor-containing compound represented by Formulas 2 to 4, 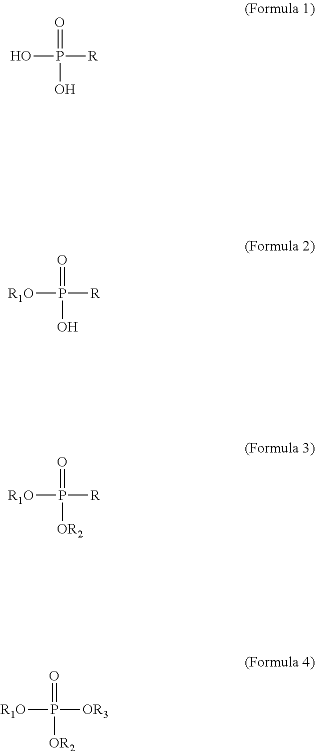
wherein R, R₁, R₂ and R₃ are each independently substituted or unsubstituted C₁-C₁₂ alkyl or substituted or unsubstituted C₆-C₁₂ aryl,
wherein the OD value of the filter for the incident light wavelength of 930-950 nm is greater than 4.

2. The filter of claim 1, wherein the substituted or unsubstituted C₁-C₁₂ alkyl is selected from the group consisting of methyl, ethyl, n-propyl, iso-propyl, n-butyl, sec-butyl, iso-butyl, tert-butyl; and the substituted or unsubstituted C₆-C₁₂ aryl is selected from the group consisting of phenyl, naphthyl and chlorophenyl.

3. The filter of claim 1, wherein the near infrared absorption layer has a haze of 0.4% or less.

4. The filter of claim 1, wherein an X-ray photoelectron spectroscopy spectrum of the near infrared absorption layer has at least one principal peak at binding energy of 930-940 eV.

5. The filter of claim 4, wherein the at least one principal peak has counts per second of 4500 or more.

6. The filter of claim 1, having an OD value for the incident light wavelength of greater than 4.5.

7. The filter of claim 1, wherein the near infrared absorption layer has a thickness of 25-150 μm.

8. The filter of claim 1, wherein the substrate layer is made of glass and has a thickness of 200-500 μm.

9. The filter of claim 1, further comprising a filtering layer on the substrate layer on the side opposite to the near-infrared absorption layer.

10. The filter of claim 9, wherein the filtering layer further comprises a first absorption dye layer and/or a second absorption dye layer, wherein the first absorption dye layer comprises a near-infrared absorption dye, and the second absorption dye layer comprises an ultraviolet absorption dye.

11. The filter of claim 10, wherein the near-infrared absorption dye is at least one selected from the group consisting of azo compounds, di-iminium compounds, benzene dithiol metal complexes, squaraine compounds, cyanine compounds and phthalocyanine compounds.

12. The filter of claim 10, wherein the ultraviolet absorption dye is at least one selected from the group consisting of azomethylene compounds, indole compounds, ketone compounds, benzimidazole compounds and triazine compounds.

13. The filter of claim 10, wherein each of the first and the second absorption dye layers has a thickness of 0.5-10 μm, and the filtering layer has an overall thickness of 0.5-10 μm.

14. The filter of claim 1, further comprising at least one anti-reflective layer on the outermost side of the filter.

15. The filter of claim 14, wherein the at least one anti-reflective layer is made of at least one material selected from TiO₂, SiO₂, Y₂O₃, MgF₂, Al₂O₃, Nb₂O₅, AlF₃, Bi₂O₃, Gd₂O₃, LaF₃, PbTe, Sb₂O₃, SiO, SiN, Ta₂Os, ZnS, ZnSe, ZrO₂, and Na₃AlF₆, and has a thickness of 0.5-10 μm.

16. The filter of claim 14, further comprising a protective layer which is made of an optical resin.

17. The filter of claim 16, wherein the protective layer has a thickness of 10-30 μm and is disposed between the infrared absorption layer and the anti-reflective layer.

18. The filter of claim 1, having an overall thickness of 225-800 μm.

19. The filter of claim 1, having a haze of 0.5% or less.

20. The filter of claim 1, having maximum transmittance of 0.01% or less for the incident light wavelength range of 930-950 nm.

21. The filter of claim 20, having maximum transmittance of 0.005% or less for the incident light wavelength range of 930-950 nm.

22. The filter of claim 1, having minimum transmittance of 80% or more for the incident light wavelength range of 460-560 nm.

23. The filter of claim 23, having minimum transmittance of 85% or more for the incident light wavelength range of 460-560 nm.

24. The filter of claim 1, wherein the filter has a passband overlaid with the wavelength range of 350-850 nm, and the central wavelength of the passband is in the wavelength range of 350-850 nm.

25. The filter of claim 24, wherein the central wavelength of the passband shifts when the filter is irradiated with incident light at incident angles of 0° vs. 30°, with the shift being 1.4 nm or less.

26. The filter of claim 25, wherein the central wavelength of the passband shifts when the filter is irradiated with incident light at incident angles of 0° vs. 35°, with the shift being 1.9 nm or less.
